(19) United States
(12) Patent Application Publication
(10) Pub. No.: US 2023/0226782 A1
(43) Pub. Date: Jul. 20, 2023

(54) MOLDED-MATERIAL MANUFACTURING APPARATUS AND METHOD OF MANUFACTURING MOLDED MATERIAL

(71) Applicant: SEIKO EPSON CORPORATION, Tokyo (JP)

(72) Inventors: Makoto YOSHIDA, Matsumoto (JP); Shinobu YOKOKAWA, Okaya (JP); Tomohiro FUJITA, Matsumoto (JP)

(21) Appl. No.: 18/153,385

(22) Filed: Jan. 12, 2023

(30) Foreign Application Priority Data
Jan. 14, 2022 (JP) 2022-004204

(51) Int. Cl. B29C 70/50; B29C 70/12

(52) U.S. Cl. CPC B29C 70/504; B29C 70/12; B29K 2201/00

(57) ABSTRACT

A molded-material manufacturing apparatus includes a deposition section configured to deposit a material containing fibers in air to form a web, a first heating section of a noncontact type configured to heat the web, and a second heating section of a contact type configured to heat and pressurize the web heated in the first heating section to form a molded material.

The present application is based on, and claims priority from JP Application Serial Number 2022-004204, filed Jan. 14, 2022, the disclosure of which is hereby incorporated by reference herein in its entirety.

### BACKGROUND

### 1. Technical Field

The present disclosure relates to a molded-material manufacturing apparatus and a method of manufacturing a molded material.

### 2. Related Art

Molded-material manufacturing apparatuses that recycle fibers in used paper or the like by a dry method are known. For example, JP-A-6-63912 discloses a manufacturing method in which fibers in used paper are defibrated by a dry method, and a polymer resin is then added to the fibers, which are then molded while being pressurized and heated.

The manufacturing method described in JP-A-6-63912 has a problem of difficulty in reducing a lead time. Specifically, in the molding process, a heating and pressing device applies heat and pressure. Heating is performed to melt the polymer resin, but molding has to be performed in a batch process. Hence, it is difficult to continuously process a resin mixed pulp raw material, which makes it difficult to reduce the lead time.

A method using pressurization and heating rollers is employed in some cases for molding. However, this method requires the polymer resin to be melted while the raw material is passing between the pressurization and heating rollers. This makes it difficult to increase the feeding rate of the raw material, and it is thus difficult to reduce the lead time. In short, a molded-material manufacturing apparatus capable of reducing the lead time in dry molding has been desired.

### SUMMARY

A molded-material manufacturing apparatus includes a deposition section configured to deposit a material containing fibers in air to form a web, a first heating section of a noncontact type configured to heat the web, and a second heating section of a contact type configured to heat and pressurize the web heated in the first heating section to form a molded material.

A method of manufacturing a molded material includes a deposition step of depositing a material containing fibers in air to form a web, a heating step of heating the web in a noncontact manner, and a molding step of heating and pressurizing the web heated in the heating step to perform molding.

### BRIEF DESCRIPTION OF THE DRAWINGS

FIG. 1 is a flowchart illustrating a method of manufacturing a molded material according to an embodiment.

FIG. 2 is a schematic diagram illustrating the configuration of a molded-material manufacturing apparatus.

### DESCRIPTION OF EXEMPLARY EMBODIMENTS

With reference to the drawings, the following embodiment describes, as examples, a molded-material manufacturing apparatus for dry molding and a method of manufacturing a molded material by dry molding. Note that for convenience of illustration, the size of each member is different from the actual size of the member. In this specification, dry molding refers to a method involving adding a relatively small amount of water compared with wet molding such as wet forming.

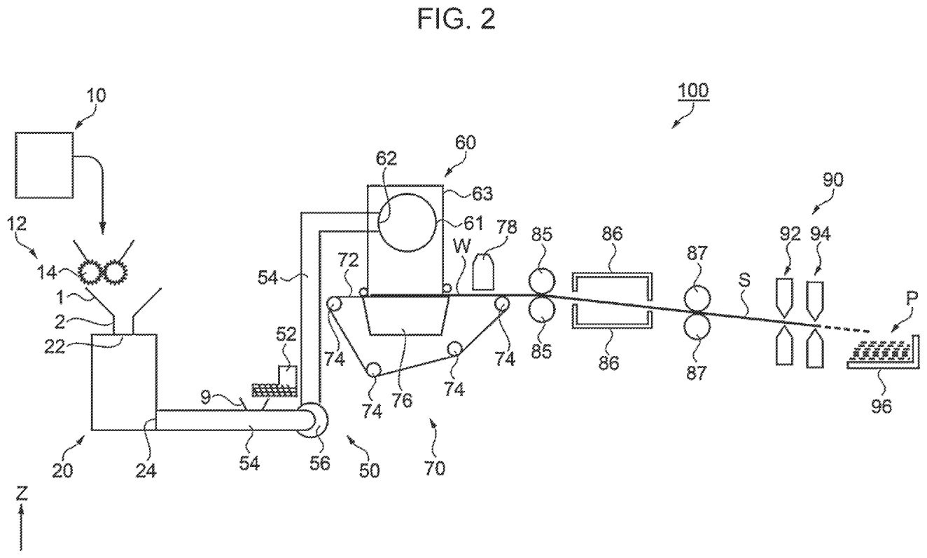

FIG. 2 described below has a Z-axis, which is a coordinate axis. The direction in which the arrow is pointing is defined as the +Z direction, and the direction opposite to the +Z direction is defined as the −Z direction. The Z-axis is an imaginary axis in the vertical direction, and the −Z direction is the vertically downward direction. The +Z direction may be referred to as the upward direction, and the −Z direction may be referred to as the downward direction. In addition, in the molded-material manufacturing apparatus, the direction in which raw materials and a web are transported may be referred to as being downstream, and the direction opposite to the transportation direction may be referred to as being upstream.

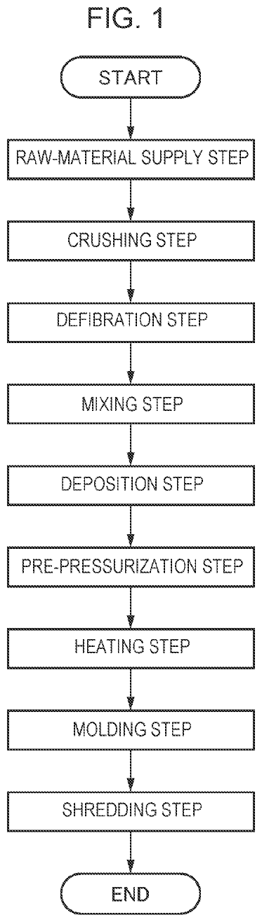

As illustrated in FIG. 1, the method of manufacturing a molded material according to the present embodiment includes a raw-material supply step, a crushing step, a defibration step, a mixing step, a deposition step, a pre-pressurization step, a heating step, a molding step, and a shredding step.

In the method of manufacturing a molded material, the molded material is manufactured through these steps in the above order from the raw-material supply step upstream to the shredding step downstream. Note that the method of manufacturing a molded material according to the present disclosure includes the deposition step, the heating step, and the molding step, and other steps are not limited to those above.

Next, a specific example of the method of manufacturing a molded material will be described along with the molded-material manufacturing apparatus. A molded-material manufacturing apparatus 100 according to the present embodiment manufactures a pellet-shaped molded material. The pellet-shaped molded material can be used for, for example, molding material for injection molding or the like. Note that the form and application of the molded material manufactured by the molded-material manufacturing apparatus 100 are not limited to the above examples. The molded-material manufacturing apparatus 100 described below is a mere example and is not limited to the one described below.

As illustrated in FIG. 2, the molded-material manufacturing apparatus 100 includes, from upstream to downstream, a supply section 10, a crushing section 12, a defibration section 20, a mixing section 50, a deposition section 60, a web transportation section 70, a pre-pressurization section 85, a first heating section 86, a second heating section 87, and a shredding section 90. In addition, although illustration is omitted, the molded-material manufacturing apparatus 100 includes a control section that integrally controls the operation of the above sections.

The supply section 10 performs the raw-material supply step. The supply section 10 supplies raw material to the crushing section 12. The supply section 10, for example, supplies the raw material to the crushing section 12 continuously and automatically. The raw material supplied by the supply section 10 is a material containing fibers.

The fibers are one of the main components of a molded material P manufactured by the molded-material manufacturing apparatus 100. The fibers affect the characteristics, such as strength, of molded products to be produced from the molded material P.

The fibers may be synthetic fibers containing plastic such as polypropylene, polyester, or polyurethane, but from the viewpoint of environment load reduction and other factors, fibers derived from natural products, in other words, fibers derived from biomass, are preferable.

Among the fibers derived from biomass, cellulose fibers are more preferable as the fibers. Cellulose fibers are derived from plants and are a relatively abundant natural material. Hence, the use of cellulose fibers promotes environment load reduction activities. Cellulose fibers also have advantages in terms of procurement and cost of the raw material. Among the various kinds of fibers, cellulose fibers theoretically have high strength and thus contribute to increasing the strength of the molded material P and molded products to be produced from the molded material P. Examples of materials containing fibers include plate-shaped pulp composed of eucalyptus or the like and used paper.

Because the first heating section 86, described later, in the molded-material manufacturing apparatus 100 is of a noncontact type, it inhibits the cellulose fibers from being damaged by heat.

The cellulose fibers are composed mainly of cellulose but may contain components other than cellulose. Examples of components other than cellulose include hemicellulose and lignin. The cellulose fibers may be ones subjected to bleaching or the like.

The crushing section 12 performs the crushing step. The crushing section 12 shreds the raw material supplied from the supply section 10 into small pieces in air or the like. The crushing section 12 is a shredder having crushing blades 14. The raw material is shredded by the crushing blades 14 into small pieces. The form of the small pieces is, for example, a substantially cubic shape with a side of several millimeters, a substantially rectangular parallelepiped shape, or the like. The small pieces of the raw material are collected into a hopper 1.

The hopper 1 includes a measurement device (not illustrated). The measurement device measures the small pieces of the raw material collected into the hopper 1 and supplies the small pieces at a constant rate to the defibration section 20 through a pipe 2 and an inlet 22.

The defibration section 20 performs the defibration step. The defibration section 20 defibrates the fibers in the supplied small pieces of the raw material into defibrated material. The term “defibrate” used herein refers to disentangling pieces each including a plurality of fibers into individual fibers.

It is preferable that the length of an individual fiber in the defibrated material be, for example, 1 μm or more and 5 mm or less, and it is more preferable that it be 2 μm or more and 3 mm or less. The length within the above range makes it easy to manufacture the molded material P and increases the strength of molded products to be produced from the molded material P.

The defibration in the defibration section 20 is performed by a dry method. Here, “dry defibration” refers to defibration performed not in liquid but in air, such as in the atmosphere.

The defibration section 20 sucks the small pieces of the raw material and generates an air flow to discharge defibrated material. With this process, the defibration section 20 sucks the small pieces of the raw material from the inlet 22 by carrying them with the air flow generated by the defibration section 20, performs the defibration process, and then transports the defibrated material into an outlet 24. The defibrated material is transported from the outlet 24 to a pipe 54. The defibrated material is transported in the pipe 54 by the air flow generated by the defibration section 20 and the air flow generated by a blower 56 described later.

The mixing section 50 performs the mixing step. The mixing section 50 mixes the defibrated material and additives to form a mixture. The mixing section 50 includes an additive supply section 52, the pipe 54, and the blower 56. The inside of the pipe 54 continues to the outlet 24 upstream. The additive supply section 52 supplies additives into the pipe 54 via a hopper 9. The additive supply section 52 includes, for example, a screw feeder or a disk feeder.

Examples of the additives include binders, colorants, mold lubricants, aggregation inhibitors, and flame retardants. As the colorant, a pigment or a dye is used. The colorant is used to color the molded material P and molded products to be produced from the molded material P. As the mold lubricant, metallic soap or the like is used. The mold lubricant improves the releasability at the time when molded products are produced from the molded material P by injection molding or the like. The aggregation inhibitor inhibits aggregation of the defibrated material and additives. The flame retardant bestows flame retardancy to the molded material P and molded products to be produced from the molded material P. Note that the additives may include antioxidants, ultraviolet absorbers, antiseptics, and antifungal agents.

The binder binds the fibers contained in the defibrated material together and improves the physical properties such as the strength of the molded material P and molded products to be produced from the molded material P. Examples of the binder include starch and dextrin that develop binding properties when water is added, thermoplastic materials such as polyvinyl alcohol, and thermosetting materials. Among these, it is preferable that the binder contain a thermoplastic material. By including a thermoplastic material, it is possible to improve the characteristics such as the physical properties of the molded material P and molded products to be produced from the molded material P. The thermoplastic material is melted in the first heating section 86 described later, which promotes mixing between the thermoplastic material and the fibers.

The thermoplastic material may be a natural resin or a thermoplastic resin, and examples of the thermoplastic material include thermoplastic resins and biodegradable plastics such as thermoplastic starch, polylactic acid, and polybutylene succinate.

Examples of the thermoplastic resin include AS resin (acrylonitrile-styrene copolymer), ABS resin (acrylonitrile-butadiene-styrene copolymer), polypropylene, polyethylene, polyvinyl chloride, polystyrene, acrylic resin, polyester resin, polyethylene terephthalate, polyphenylene ether, polybutylene terephthalate, nylon, polyamide, polycarbonate, polyacetal, polyphenylene sulfide, and polyether ether ketone. These resins can be used independently or as a mixture as appropriate. These resins may be subjected to copolymerization or modification, and examples of such resins include styrene-based resins, acrylic-based resins, styrene-acrylic-based copolymer resins, olefin-based resins, vinyl-chloride-based resins, polyester-based resins, polyamide-based resins, polyurethane-based resins, polyvinyl-alcohol-based resins, vinyl-ether-based resins, N-vinyl-based resins, and styrene-butadiene-based resins.

The shape of the foregoing additives may be particulate or fibrous. When the additives are particulate, it is preferable that the average particle diameter be 100 μm or less, and it is more preferable that it be 10 μm or less. This configuration improves the miscibility between the defibrated material and the additives and also prevents separation of the additives from the mixture. Note that the term “average particle diameter” used herein denotes the volume-based particle size distribution (50%) measured by a dynamic light scattering method.

When the additives are fibrous, it is preferable that the fiber length be 50 μm or more and 100 mm or less, and it is more preferable that it be 30 mm or less. Note that the term “fiber length” used herein denotes the average fiber length (mm) measured by a staple diagram method.

The molded-material manufacturing apparatus 100 may include one or more additive supply sections 52. When the molded-material manufacturing apparatus 100 includes one additive supply section 52, a plurality of additives mixed in advance are supplied. Alternatively, the molded-material manufacturing apparatus 100 may have two or more additive supply sections 52, and each additive supply section 52 may individually supply an additive.

The blower 56 generates an air flow inside the pipe 54. The air flow mixes the defibrated material having reached the pipe 54 and the additives to form a mixture and transports the mixture in the downstream direction. The mechanism that mixes the defibrated material and the additives is not limited to the blower 56 and may be blades rotating at high speed or may be a V mixer or the like that utilizes the rotation of a container. The mixture is transported to the deposition section 60 through the pipe 54.

The deposition section 60 performs the deposition step. The deposition section 60 deposits the mixture, which is material containing fibers, in air and forms a web W. The deposition section 60 includes a drum portion 61 and a housing portion 63 that houses the drum portion 61. The deposition section 60 takes the mixture into the drum portion 61 through an inlet 62 and deposits the mixture on a mesh belt 72 by a dry method.

The web transportation section 70 including the mesh belt 72 and a suction mechanism 76 is located below the deposition section 60. The suction mechanism 76 is located to be opposed to the drum portion 61 with the mesh belt 72 in between in a direction along the Z-axis.

The drum portion 61 is a columnar sieve rotationally driven by a motor (not illustrated). A side surface of the columnar drum portion 61 has a screen having a function of a sieve. The drum portion 61 allows the fibers and the particles of the additives smaller than the size of the openings of the sieve to pass through from the inside to the outside. Tangled fibers in the mixture are untangled by the drum portion 61 and dispersed in the air inside the housing portion 63.

Note that the sieve of the drum portion 61 does not necessarily have a function of screening long fibers or the like in the mixture. In other words, the drum portion 61 may untangle the fibers in the mixture and discharge all of the mixture into the housing portion 63. The mixture dispersed in the air inside the housing portion 63 is deposited on the upper surface of the mesh belt 72 due to gravity and the suction of the suction mechanism 76.

The web transportation section 70 includes the mesh belt 72 and the suction mechanism 76. The web transportation section 70 promotes the deposition of the mixture onto the mesh belt 72 by using the suction mechanism 76. The web transportation section 70 transports the web W formed from the mixture in the downstream direction by the rotation of the mesh belt 72.

The suction mechanism 76 is located below the drum portion 61. The suction mechanism 76 sucks the air in the housing portion 63 through a plurality of holes in the mesh belt 72. With this configuration, the mixture discharged to the outside of the drum portion 61 is sucked downward together with air and is deposited on the upper surface of the mesh belt 72. The suction mechanism 76 employs a publicly known suction device such as a blower.

The plurality of holes in the mesh belt 72 allow air to pass through but do not allow the fibers and the additives contained in the mixture to pass through easily. The mesh belt 72 is an endless belt and is stretched around four tension rollers 74.

The upper surface of the mesh belt 72 is moved in the downstream direction by the rotation of the tension rollers 74. In other words, the mesh belt 72 rotates clockwise in FIG. 2.

The suction mechanism 76 sucks the air inside the housing portion 63, in which the mixture is dispersed, through the plurality of holes in the mesh belt 72. With this operation, the mixture is attracted and deposited onto the upper surface of the mesh belt 72. In this process, since the mesh belt 72 is rotated by the tension rollers 74, the mixture being continuously deposited forms the web W. The web W contains a relatively large amount of air and is soft and swollen. The web W is transported along with the movement of the mesh belt 72 toward the pre-pressurization section 85 located downstream.

The thickness of the web W is set to, for example, 800 g/m² or more and 1200 g/m² or less. The thickness of the web W is adjusted by the amount of the mixture transported to the deposition section 60 per unit time, the rotation speed of the mesh belt 72, and the like.

The fiber content of the web W relative to the total mass of the web W is, for example, 10% by mass or more and 90% by mass or less, preferably 20% by mass or more and 80% by mass or less, and more preferably 40% by mass or more and 60% by mass or less.

The thermoplastic-material content of the web W relative to the total mass of the web W is, for example, 1% by mass or more and 90% by mass or less, preferably 5% by mass or more and 80% by mass or less, and more preferably 40% by mass or more and 60% by mass or less.

The additive content of the web W, such as thermoplastic material, and the fiber content of the web W are adjusted by the amount of the defibrated material transported and supplied from the defibration section 20 to the pipe 54, the amount of additives supplied from the additive supply section 52, and other factors.

Here, the web W formed on the mesh belt 72 may be humidified. Specifically, for example, a humidification section 78 is provided above the transportation route of the web W. The humidification section 78 sprays water mist onto the web W to humidify it. The humidification section 78 employs a publicly known spray device such as a sprayer. When using starch or the like as a binder, the humidification of the web W causes the binder to absorb water, increasing the strength of the molded material P and molded products to be produced from the molded material P.

The pre-pressurization section 85 performs the pre-pressurization step. The pre-pressurization section 85, which is located upstream of the first heating section 86 described later, pressurizes the web W in a preparatory manner. The pre-pressurization section 85 is, for example, a calendering device and has a pair of rollers.

The web W is pulled into the pre-pressurization section 85 from the mesh belt 72 and moves downstream while being pressurized between the pair of rollers. With this process, the web W is compressed, and the thickness in the direction of the pressure applied to the web W becomes thinner. This makes it easy for the heat applied in the first heating section 86 located downstream to be transmitted in this direction of the web W, making heating the web W efficient.

The density of the web W having passed through the pre-pressurization section 85 is set to, for example, 0.6 g/cm³ or more and 1.2 g/cm³ or less. This density of the web W is adjusted by the pressurization conditions of the pre-pressurization section 85. The web W having passed through the pre-pressurization section 85 moves to the first heating section 86.

The first heating section 86 performs the heating step. The first heating section 86 is a noncontact heater that heats the web W. Specifically, the first heating section 86 is an oven and, for example, emits far-infrared rays to the web W to heat it. The web W is heated in a noncontact manner while moving downstream inside the first heating section 86. Thus, it is possible to increase the efficiency of heating the web W and transporting the web W. In addition, it is possible to prevent or reduce damage to the cellulose fibers and the like contained in the web W due to heat.

It is preferable that the heating temperature realized by the first heating section 86 be within the temperature range of ±20° C. of the melting temperature of the thermoplastic material contained in the web W. This configuration promotes melting of the thermoplastic material contained in the web W, thereby promoting mixing of the fibers and the additives including the thermoplastic material. Note that the melting temperature of a thermoplastic material in this specification refers to the melting point of the thermoplastic material. The web W having passed through the first heating section 86 moves to the second heating section 87.

Here, the deposition section 60, the web transportation section 70, the pre-pressurization section 85, and the first heating section 86 described above promote dispersion of the fibers and additives contained in the web W, reducing uneven distribution of these raw materials in the molded material P. Since an uneven density of the raw materials in the web W is reduced, the pressurization pressure of the second heating section 87 located downstream is applied uniformly to the web W. This reduces a variation in the thickness of molded material S described later.

The second heating section 87 performs the molding step. The second heating section 87 heats and pressurizes the web W heated by the first heating section 86 to form the molded material S. The second heating section 87 is a contact heating device and has a pair of heating rollers.

Each of the pair of heating rollers of the second heating section 87 has a built-in electric heater and has a function of heating the surface of the roller. The web W passes continuously between the pair of heating rollers, and the web W is press-worked while being heated. This process produces the molded material S in the form of a continuous sheet in which the fibers are bound together by the binder.

Since the second heating section 87 has a pair of heating rollers, the web W is heated and pressurized in parallel, and the molding is continuously performed. This further reduces the lead time compared with a batch process using a heating and pressing device or the like. Since the web W is heated in advance by the first heating section 86, the contact time between the web W and the pair of heating rollers of the second heating section 87 can be short. This prevents or reduces damage to the cellulose fibers or the like contained in the web W due to heat.

It is preferable that the heating temperature in the second heating section 87 be within the temperature range of ±20° C. of the melting temperature of the thermoplastic material contained in the web W. With this setting, melting of the thermoplastic material contained in the web W is completed, and the fibers and the additives including the thermoplastic material are mixed. The molded material S moves from the second heating section 87 to the shredding section 90.

The shredding section 90 performs the shredding step. The shredding section 90, which is what is known as a shredder, shreds the molded material S in the form of a continuous sheet into pieces of pellet-shaped molded material P. The shredding section 90 includes a first shredding section 92 and a second shredding section 94.

The first shredding section 92 shreds the molded material S in the direction being the transportation direction of the molded material S. The second shredding section 94 shreds the molded material S in a direction intersecting the transportation direction of the molded material S. Since the shredding section 90 has the first shredding section 92 and the second shredding section 94, a variation in the shape of the molded material P is small, and it is easy to mass-produce the molded material P.

The molded material S is shredded into the molded material P, which is stored in a tray 96. Note that instead of the molded material S being transported to the shredding section 90, the molded material S may be removed as a finished product. The molded material S may be cut into sheets having a desired size, which may then be used as finished products.

The present embodiment provides the following effects.

The lead time in dry molding can be shortened. Specifically, since the web W is heated in the first heating section 86 in a noncontact manner, it is easy to transport the web W while heating it. This makes it possible to perform the process continuously while applying enough heat to the web W in the first heating section 86. In addition, since the web W is heated in the first heating section 86, the time taken to heat the web W in the second heating section 87 is shortened. With the above configuration, it is possible to provide a molded-material manufacturing apparatus 100 and a method of manufacturing a molded material P that shorten the lead time in dry molding.

What is claimed is:

1. A molded-material manufacturing apparatus comprising:
a deposition section configured to deposit a material containing fibers in air to form a web;
a first heating section of a noncontact type configured to heat the web; and
a second heating section of a contact type configured to heat and pressurize the web heated in the first heating section to form a molded material.

2. The molded-material manufacturing apparatus according to claim 1, wherein
the first heating section is an oven.

3. The molded-material manufacturing apparatus according to claim 1, wherein
the second heating section includes a heating roller.

4. The molded-material manufacturing apparatus according to claim 1, further comprising
a pre-pressurization section located upstream of the first heating section and configured to pressurize the web.

5. A method of manufacturing a molded material, comprising:
a deposition step of depositing a material containing fibers in air to form a web;
a heating step of heating the web in a noncontact manner; and
a molding step of heating and pressurizing the web heated in the heating step to perform molding.

6. The method of manufacturing a molded material according to claim 5, wherein
the web contains a thermoplastic material.

7. The method of manufacturing a molded material according to claim 5, wherein
the fibers are cellulose fibers.
